(19) United States
(12) Patent Application Publication
(10) Pub. No.: US 2005/0216779 A1
(43) Pub. Date: Sep. 29, 2005

(54) Device and method for managing a standby state of microprocessor

(75) Inventors: Olivier Ferrand, Carry Le Rouet (FR); Jean-Michel Gril-Maffre, Aix-en-Provence (FR)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 11/083,350

(22) Filed: Mar. 16, 2005

(30) Foreign Application Priority Data
Mar. 18, 2004 (FR) 0402815

(51) Int. Cl. G06F 1/26

(52) U.S. Cl. 713/324

(57) ABSTRACT

A microprocessor includes a computation unit for executing operations respectively associated with instructions of a determined set of instructions of the microprocessor. A control unit interprets the instructions and controls the computation unit accordingly. The microprocessor further includes a blocking unit which is controlled by the control unit in response to the execution of a standby instruction belonging to the set of instructions for placing the microprocessor in a standby state during an undetermined period. The exit of the microprocessor from the standby state is conditioned by a determined value or a determined change of the value of a condition bit stored in a condition register, which is internal or external to the microprocessor.

### PRIORITY CLAIM

This application claims priority from French Application for Patent No. 04 02815 filed Mar. 18, 2004, the disclosure of which is hereby incorporated by reference.

### BACKGROUND OF THE INVENTION

1. Technical Field of the Invention

The present invention relates in a general manner to the management of a standby state of a microprocessor. The invention relates more particularly to a microprocessor and to a method of control of such a microprocessor to place it in a standby state during an undetermined period.

2. Description of Related Art

In conventional microprocessors, standby awaiting an event to condition the exit of the microprocessor from the standby state may be effected by two distinct procedures.

The first procedure consists in standing by to await the change of value of a bit of a status register by means of a software loop. Nevertheless this solution has two drawbacks.

A first drawback is that the microprocessor continues to operate while waiting for the change of state of the bit concerned of the status register. Its power consumption is therefore of the same order of magnitude as during the normal execution of any program although it is merely standing by waiting for an event without performing any operation useful to the application.

A second drawback is that several instructions are required to carry out this loop, their number depending on the instruction set of the microprocessor. The duration between the change of the value of the bit of the status register and the exit from the loop may therefore be several clock cycles. Moreover, according to the moment at which the bit changes value, the duration between the change of value of the bit and the exit from the loop is variable and unpredictable.

These two drawbacks are particularly problematic in the case of applications that are very sensitive to execution time such as those based on a telecommunication protocol, for example.

The second procedure consists in using an interrupt mechanism, it being possible for the microprocessor to be put into the standby state and to exit this standby state through the generation of an appropriate interrupt. This solution makes it possible to stop the microprocessor and hence to considerably decrease its energy consumption but it also has two drawbacks.

A first drawback is that it requires the implementation of a hardware function dedicated to the generation of the interrupt in the macro cell which must be able to place the microprocessor in the standby state, as well as the presence of a cell for managing the interrupts.

The second drawback is that the interrupt mechanisms are generally even slower than the production of a software loop since, when an interrupt is generated, the microprocessor saves the execution context (value of the registers and address for return after processing of the interrupt) in a program memory, and then has to restore the execution context to continue the normal execution of the program at the end of the interrupt. This restore represents a time equivalent to the execution of several instructions.

### SUMMARY OF THE INVENTION

To alleviate the aforesaid drawbacks of the prior art, embodiments of the present invention integrate a specific instruction, from the microprocessor instruction set, to stop the microprocessor, the exit of the microprocessor from the standby state being conditioned by the value of a determined bit, the bus of the microprocessor being frozen in a state of reading the register storing said bit and the core of the microprocessor being placed on standby.

The invention more particularly proposes a microprocessor comprising a computation unit for executing operations respectively associated with instructions of a determined set of instructions of the microprocessor and a control unit for interpreting the instructions and controlling the computation unit accordingly.

Advantageously, the microprocessor comprises a blocking unit which is controlled by the control unit in response to the execution of a standby instruction belonging to the set of instructions for placing the microprocessor in a standby state, the exit of the microprocessor from the standby state being conditioned by a determined value or a determined change of the value of a condition bit stored in a condition register.

In response to the execution of the standby instruction, the control unit configures a bus to read the condition register so that it delivers the data stored in the register to blocking unit.

In a first embodiment, the standby instruction comprises values specified as parameters of said instruction including at least the address of the condition register and at least the rank of the condition bit in said condition register. A single instruction therefore makes it possible to go to the standby state and to choose that register bit with regard to which the standby will be effected.

The values specified as parameters of the standby instruction further include the value of a parameter coding the change of the value of the condition bit which conditions the exit of the microprocessor from the standby state.

In a second embodiment, the microprocessor comprises an internal mode register for storing the value of a parameter coding the value or the change of value of the condition bit which conditions the exit of the microprocessor from the standby state.

In a third embodiment, the blocking unit comprises a selection unit for selecting, at each clock cycle of the microprocessor, the condition bit among the bits of the condition register that are read by the bus in read mode.

In a fourth embodiment, the blocking unit comprises a monitoring unit for testing the condition bit at each clock cycle of the microprocessor. The monitoring unit may deliver a blocking signal on an input for activating and deactivating at least one unit for processing instructions belonging to the control unit, so as to interrupt and block the processing of the instructions in order to place the microprocessor in the standby state. Thus, the latency time is predictable and is equal to a clock cycle for the exit of the microprocessor from the standby state. As soon as the bit changes value, the microprocessor can again execute the next instruction at the next clock cycle.

In one embodiment, the unit for processing the instructions can be a retrieval unit which retrieves, from a program memory, instructions to be executed.

In another embodiment, the unit for processing instructions can also be an instruction register which stores an instruction to be executed.

In another embodiment, the unit for processing instructions is an ordinal counter which stores the address of a next instruction to be executed.

In general, the unit for processing instructions may also be a decoding unit which decodes an instruction to be executed.

In a fifth embodiment, the selection unit is a multiplexer comprising a number of input data which is equal to the size in number of bits of the condition register, addressing inputs representative of the coding of the rank of the condition bit in the condition register and an output which delivers the current value of the condition bit to the monitoring unit at each clock cycle of the microprocessor.

In a sixth embodiment, the monitoring unit is a multiplexer comprising two complementary inputs which respectively receive the value of the condition bit and its logical complement, an addressing input which receives a value of a transition parameter and an output which delivers the blocking signal.

As a variant, the monitoring unit may be a comparator comprising two inputs which respectively receive the value of the transition parameter and the value of the condition bit, and an output which delivers the blocking signal.

In another variant, the monitoring unit may be an inverted XOR gate comprising two inputs which respectively receive the value of the condition bit and the transition parameter, and an output which delivers the blocking signal.

Advantageously, the monitoring unit may be sensitive to a signal edge so as to react to a change of value of the condition bit.

The invention also proposes a method for the control of a microprocessor comprising a computation unit for executing operations respectively associated with instructions of a determined set of instructions of the microprocessor and a control unit for interpreting the instructions and controlling the computation unit accordingly, which method comprises the steps according to which:
the control unit activates a blocking unit in response to the execution of a standby instruction;
the blocking unit interrupts and blocks the processing of the instructions so as to place the microprocessor in a standby state;
the control unit configures a bus to read a condition register, so that it delivers data stored in the condition register to the blocking unit; and
the blocking unit monitors the value or the change of the value of a condition bit of the condition register which conditions the exit of the microprocessor from the standby state.

Advantageously, the method may also comprise an optional configuration step which comprises:
the specification of the address of the condition register as parameter of the standby instruction; and
the specification of the rank of the condition bit in the condition register as parameter of the standby instruction.

In a first implementation, the configuration step comprises the specification of a transition parameter as parameter of the standby instruction whose value codes the value or the change of value of the condition bit which conditions the exit of the microprocessor from the standby state.

In a second implementation, the configuration step furthermore comprises the configuration of a mode register internal or external to the microprocessor, so as to store in the mode register a transition parameter whose value codes the value or the change of the value of the condition bit which conditions the exit of the microprocessor from the standby state.

This second implementation is particularly beneficial when the microprocessor exhibits an RISC (“Reduced Instruction Set Computer”) architecture. Specifically, for RISC microprocessors, the instructions of the microprocessor instruction set are the same fixed size (in terms of number of bits). This constraint necessitates the coding of a maximum of information on a coding space of determined size.

Thus, the configuration of a mode register to store the transition parameter makes it possible to free up the memory space allocated for the coding of the transition parameter.

Said memory space can thus be used differently as, for example, the coding of a value indicating the number of changes of the condition bit before the exit of the microprocessor, or other.

An advantage of the present invention is that certain parts of the microprocessor are halted, thereby considerably reducing the energy consumption of the microprocessor. Indeed, the logic units which execute operations are not invoked during the standby state and therefore do not consume any energy.

In accordance with another embodiment of the invention, an apparatus comprises a computation unit for a microprocessor and a register storing a value indicative of whether the microprocessor is or is not in standby mode. A control unit includes an enable input and is operable responsive to receipt of an enable signal in a first state to interpret program instructions and control operation of the computation unit according to those instructions and further operable responsive to receipt of the enable signal in a second state to interrupt and block processing of the program instructions. A blocking unit configures a bus to read the value from the register and generates the enable signal in the first state if the microprocessor is not in standby mode and generates the enable signal in the second state if the microprocessor is in the standby mode.

### BRIEF DESCRIPTION OF THE DRAWINGS

Other characteristics and advantages of the invention will become further apparent on reading the description which follows. The latter is purely illustrative and should be read in conjunction with the appended drawings, in which:

FIGS. 1a and 1b are diagrams illustrating exemplary coding formats of a standby instruction according to embodiments of the present invention;

FIG. 2 is a block diagram illustrating an embodiment of a microprocessor according to the present invention;

FIG. 3 is a block diagram illustrating a first embodiment of a monitoring unit according to the present invention;

FIG. 4 is a block diagram illustrating a second embodiment of a monitoring unit according to the present invention;

FIG. 5 is a block diagram illustrating a rising edge detector;

FIG. 6 is a block diagram illustrating a falling edge detector; and

FIG. 7 is a flowchart illustrating an implementation of the method according to the invention.

### DETAILED DESCRIPTION OF THE DRAWINGS

In what follows, we consider the example of a 16-bit microprocessor exhibiting an RISC (“Reduced Instruction Set Computer”) architecture, that is to say a microprocessor in which the size in terms of number of bits of the instructions is fixed and equal to 16 bits.

The execution of the standby instruction, which is an instruction from the instruction set of a microprocessor 30, is intended to generate a standby state of the microprocessor 30 during an undetermined period which is dependent on a change of value of a bit defined by a user and stored in a register. Subsequently in the description, the bit whose state conditions the exit of the microprocessor from the standby state is called the “condition bit”, and the register which stores the condition bit is called the “condition register” 100. The condition register 100 is internal or external to the microprocessor.

More formally, the microprocessor exits the standby state when the value of the condition bit attains a value of a transition parameter likewise defined by the user. Such a transition parameter takes the binary value “0” or “1”.

The execution of the standby instruction thus configures the conditioning of the exit of the microprocessor from the standby state and therefore comprises values specified as parameter of the instruction including at least the address of the condition register and at least the rank of the condition bit in the condition register.

As a variant, the exit of the microprocessor 30 from the standby state is conditioned by the transition of the change of the value of the condition bit to the value of the transition parameter. More precisely, the exit of the microprocessor 30 from the standby state is conditioned by the rising edge of the “0 to 1” transition of the state of the condition bit or the falling edge of the “1 to 0” transition of the state of the condition bit, the transition to be detected being dependent on the transition parameter.

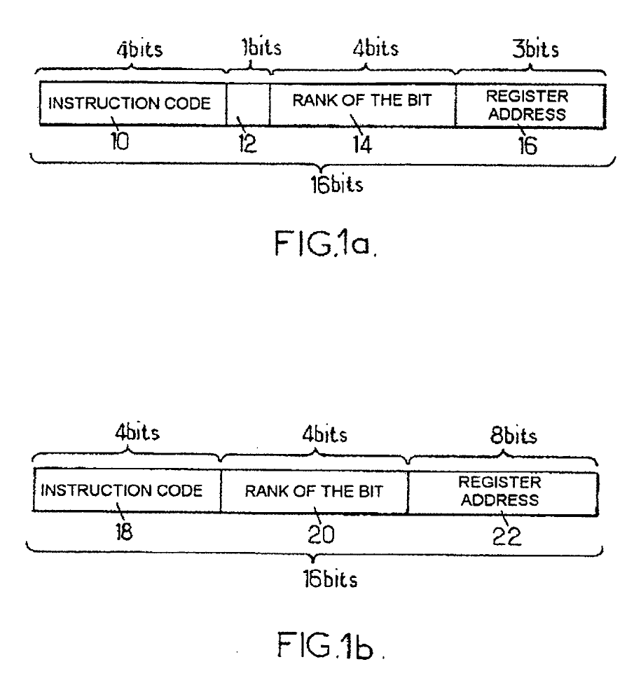

FIGS. 1a and 1b are diagrams of the coding formats of a standby instruction according to embodiments of the present invention.

In a first embodiment, the standby instruction, coded on 16 bits, comprises four data fields including:—
a first field 10 which contains the code of the standby instruction and which is coded for example on four bits;
a second field 12 which contains the value of the transition parameter and which is coded for example on one bit;
a third field 14 which contains the rank of the condition bit in the condition register and which is coded for example on four bits;
a fourth field 16 which contains the address of the condition register and which is coded for example on three bits.

In a second embodiment, the standby instruction, coded on 16 bits, comprises three data fields including:
a first field 18 which contains the code of the standby instruction and which is coded for example on four bits;
a second field 20 which contains the rank of the condition bit in the condition register and which is coded for example on four bits;
a third field 22 which contains the address of the condition register and which is coded for example on eight bits.

In the second embodiment, the value of the transition parameter is stored in a mode register 62 of the microprocessor 30. The mode register is configured via instructions belonging to the instruction set of the microprocessor 30 such as for example, a load instruction which stores the value of the transition parameter in an allocated memory space of the mode register. The value of the condition parameter and the address of the memory space are specified as parameters of the load instruction.

Of course, the size in terms of number of bits of the various fields, which is given by way of example for the two aforesaid embodiments, is not limiting and may differ from one microprocessor to another, in particular on account of their different architecture.

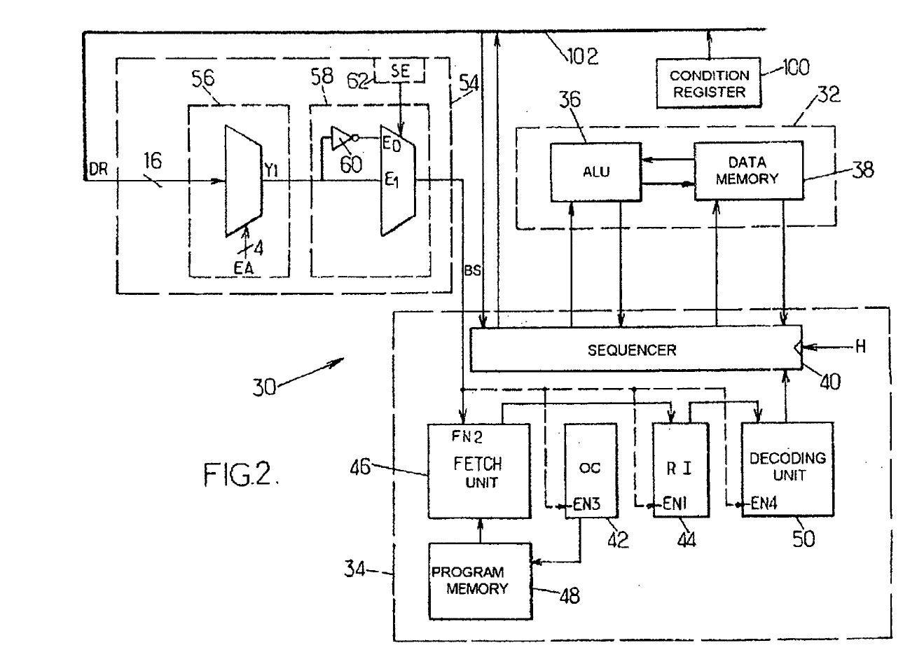

FIG. 2 illustrates an embodiment of a microprocessor 30 according to the invention.

The microprocessor 30 comprises a computation unit 32 (or execution unit) for executing operations associated with instructions of an instruction set of the microprocessor 30, and a control unit 34 for interpreting the instructions and controlling the computation unit 32 accordingly, in tempo with clock cycles H.

The computation unit 32 comprises:
an arithmetic and logic unit 36 (ALU) for performing elementary operations such as additions, multiplications or the like and which comprises logic units performing the elementary operations such as adders, multipliers or the like; and
a data memory 38, comprising memories and registers, which stores data specific to the various elementary operations.

The control unit 34 comprises units for processing the instructions, in particular:
a sequencer 40 which generates in tempo with the clock cycles H control signals delivered to the various logic units of the computation unit 32 which participate in the execution of a given instruction;
an ordinal counter 42 (OC) which is a register storing the address of the next instruction to be executed;
an instruction register 44 (R) which receives the instruction to be executed;
a program memory 48 such as for example a memory of ROM (Read Only Memory) type, Flash EPROM (Electrically Programmable Read/Only Memory) or EEPROM (Electrically Erasable and Programmable EPROM) type;
a retrieval unit 46 (“fetch unit”) which retrieves a program instruction to be executed from the program memory 48; and
a decoding unit 50 which decodes and interprets the instruction to be executed, and which determines the elementary operations to be performed and the operands.

The control unit 34 has the function of interpreting the instructions and of controlling the various logic units of the computation unit 32 accordingly. In a more detailed manner it serves in particular to:
address the next instruction in program memory 48;
decode the next instruction once it is loaded into the instruction register 44;
search for the data to be processed, in the program memory 48 and/or in the data memory 38;
deliver the data as input to the computation unit 32;
indicate the operation that the computation unit 32 is to perform; and
possibly transfer the result(s) of the elementary operation to the data memory 38.

The microprocessor 30 furthermore comprises a blocking unit 54 whose function is to interrupt and block the processing of the instruction set so as to place the microprocessor in a standby state.

The blocking unit 54 comprises:
a selection unit 56 which, at each clock cycle of the microprocessor, selects from among the bits stored in the condition register the condition bit and which delivers the value of the condition bit to a monitoring unit 58; and
a monitoring unit 58 for testing and comparing the value of the condition bit with respect to the value of the transition parameter. The monitoring unit 58 delivers a blocking signal BS to at least one unit for processing instructions so as to interrupt and block the processing of the instructions in order to place the microprocessor 30 in the standby state. The blocking signal BS is delivered as long as the value of the condition bit is different from the value of the transition parameter.

As described previously, as a variant, the monitoring unit 58 is sensitive to a transition of the change of the value of the condition bit to the value of the transition parameter, that is to say it is sensitive to a rising edge for a “0 to 1” transition (that is to say the transition parameter is equal to “1”) or to a falling edge for a “1 to 0” transition (that is to say the transition parameter is equal to “0”). More formally, the monitoring unit 58 is sensitive to a signal edge so as to react to a change of value of the condition bit.

The selection unit 56 is a multiplexer, comprising 16 data inputs DR, four address inputs EA and an output Y1. In particular, the 16 data inputs DR correspond to the values of the 16 bits read from the condition register and the four address inputs EA correspond to the coding of the rank of the condition bit in the condition register. The output Y1 corresponds to the value of the condition bit thus selected at each clock cycle of the microprocessor.

The selection of the condition bit is dependent on the values on the four addressing inputs S3, S2, S1, and S0, representative of the binary coding of the rank of the condition bit in the condition register where, for example, S0 is the least significant bit and S3 is the most significant bit. For example, if one wishes the exit of the microprocessor 30 from the standby state to be conditioned by the fourth bit of the register (starting from the least significant bit) the four address inputs will have values S0=0, S1=0, S2=1 and S3=0 i.e. the number “0100” in binary representation or the number “4” in decimal representation. Once the condition bit has been selected, the selection multiplexer delivers as output Y1 a signal representative of the values of the condition bit at each clock cycle of the microprocessor 30.

The monitoring unit 58 is a multiplexer, comprising two complementary data inputs E0 and E1, an addressing input SE and an output Y2 which delivers the blocking signal BS. One of the two inputs of the multiplexer is linked to an inverter 60 so as to obtain a complementary value with the other input. For example, the input E0 is linked to the inverter 60. The input E1 is linked to the output Y1 of the multiplexer and therefore receives a signal representative of the values of the condition bit. The addressing input SE of the monitoring multiplexer corresponds to the value of the transition parameter equal to “0” or “1”.

When the addressing input SE is equal to “1”, the output Y2 of the multiplexer is equal to the value of E0, i.e., “0” if the value of the condition bit is equal to “1”, and “1” if the value of the condition bit is equal to “0”.

Likewise, when the addressing input SE is equal to “0”, the output Y2 of the multiplexer is equal to the value of E1, i.e., “0” if the value of the condition bit is equal to “0”, and “1” if the value of the condition bit is equal to “1”.

The blocking signal BS therefore takes the value “1” when the value of the condition bit is different from that of the transition parameter and takes the value “0” when the value of the condition bit is equal to that of the transition parameter.

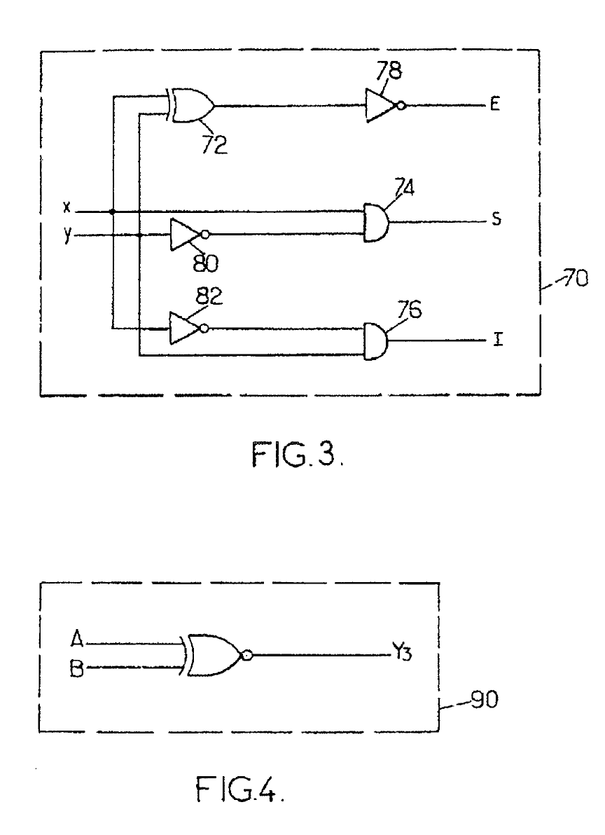

In another embodiment, the monitoring unit 56 is a comparator with two input x and y, and three outputs E, S and I as is illustrated in FIG. 3. The comparator comprises several logic units such as an XOR-type gate 72, two AND-type gates 74 and 76, and three inverters 78, 80, 82. The output E is representative of the equality of the parameters x and y when the output has the value “1”. The output S indicates that the parameter x is greater than the parameter y when the output has the value “1”. The output I indicates that the parameter x is less than the parameter y when the output has the value “1”. Of course, within the context of the invention, only the output E is of interest to us.

More precisely, the input x corresponds to the transition parameter and the input y corresponds to the value of the condition bit. The output E therefore delivers the blocking signal BS which takes the value “1” when the condition bit is equal to the transition parameter and which takes the value “0” when the condition bit is different from the transition parameter.

In another embodiment, the monitoring unit 58 is a logic unit such as illustrated in FIG. 4, for example an inverted XOR-type gate 90 comprising two inputs A and B, and an output Y3 which delivers the blocking signal BS. The input A corresponds to the value of the condition bit and the input B corresponds to the transition parameter. Thus, the blocking signal BS has the value “1” only if the two inputs have like values.

As described previously in a variant embodiment, the monitoring unit 58 is sensitive to the rising edges and falling edges of a signal, with selectivity of the edge depending on the transition parameter. For this purpose, the monitoring unit 58 comprises a rising edge detector illustrated in FIG. 5 and a falling edge detector illustrated in FIG. 6. The detectors are linked, for example, in parallel to the input of the monitoring unit which receives the signal representative of the values of the condition bit.

Thus, the monitoring unit moreover comprises a selectivity unit for selecting one of the two detectors as a function of the transition parameter. For example, the selectivity unit is a switch which selects the rising edge detector when the transition parameter is equal to “1” and which selects the falling edge detector when the transition parameter is equal to “0”. Such a switch is, for example, placed upstream of the detectors.

In what follows, the manner of operation of the blocking unit 54 in response to the execution of the standby instruction is now described.

Once the standby instruction has been executed, the control unit 34 configures a bus 102 to read the condition register and activates the blocking unit 54. The bus 102 is an internal bus in the case where the condition register is internal to the microprocessor or is an external bus in the case where the condition register is external to the microprocessor.

The bus in read mode then transmits the data DR read from the condition register, at each clock cycle of the microprocessor, to the selection unit 56. In particular, the bus in read mode transmits the 16 data DR from the condition register respectively to the 16 data inputs of the multiplexer of the selection unit.

The blocking unit 54 interrupts and blocks the processing of the instructions. For example, the blocking unit 54 blocks the storage of the instructions in the instruction register 44. Thus, no instruction will be decoded and executed as long as the blocking of the instruction register 44 is effective. For example, the blocking signal BS is delivered to an activating and deactivating input EN1, the so-called “ENABLE input”, of the instruction register 44.

According to other variants, the blocking unit 54 interrupts and blocks the processing of the instructions by deactivating at least one unit for processing instructions such as the retrieval unit 46 and/or the ordinal counter 42 and/or the decoding unit 50. The blocking signal BS is thus delivered accordingly on one of the respective activating and deactivating inputs EN2, EN3 and EN4 of the units for processing instructions.

When the monitoring unit 58 detects a change (or a transition according to the variant described) of the value of the condition bit, the blocking signal BS is no longer delivered and the processing of the instructions resumes its normal course. The microprocessor 30 exits the standby state at the next clock cycle according to the change of the value of the condition bit. Specifically, the reading of the condition register is performed at each clock cycle, thus allowing the microprocessor to exit the standby state as soon as the value of the condition bit changes.

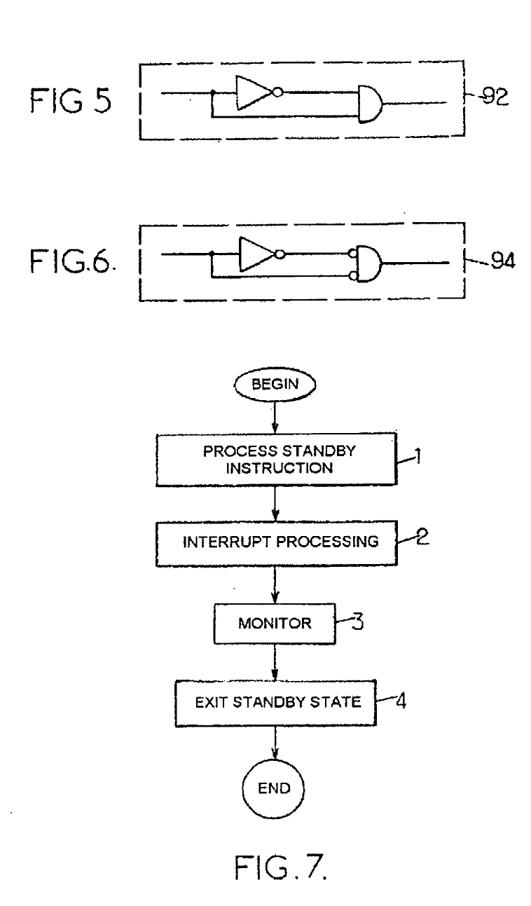

FIG. 7 is a flowchart illustrating a mode of implementation of the method according to the present invention.

The method comprises a first optional parameterization step 1 for parameterizing the address of the condition register and the rank of the condition bit to be monitored in the register. The address and the rank are values specified as parameters of the standby instruction, as is illustrated in FIG. 1b. The transition parameter is stored in a mode register by configuring the mode register, as was described previously.

As a variant, the transition parameter is also specified as parameter of the standby instruction, as illustrated in FIG. 1a. This avoids the need to provide and use a mode register.

In a second blocking step 2, the control unit 34 processes, decodes and executes the standby instruction. In response to the execution of the instruction, the control unit 34 activates the blocking unit which interrupts and blocks the processing of the instructions via the blocking signal BS delivered to at least one unit for processing instructions, and configures a bus 102 to read the condition register 100.

In a third monitoring step 3, the bus 102 in read mode delivers the data DR read from the condition register 100 to the selection unit 56 at each clock cycle of the microprocessor 30. The selection unit 56 selects the condition bit from among the data DR and delivers the values of the selection bit to the monitoring unit 58 which monitors the “0 to 1” or “1 to 0” transition of the condition bit.

As soon as a transition of the value of the condition bit is detected, the blocking unit 54 no longer delivers the blocking signal and permits, in a fourth step 4, resumption of the processing of the instructions and consequently exit of the microprocessor from the standby state. The blocking unit is then deactivated.

The foregoing description is not limiting and the present invention applies also to conventional microprocessors such as CISC (“Complex Instruction Set Computer”) microprocessors and to microprocessors with or without execution pipeline.

Likewise, the size in terms of number of bits of the instructions processed by the microprocessor is not limiting and the present invention also relates to instructions of variable or fixed size in terms of number of bits, equal for example to 8 bits, 16 bits, 32 bits or more.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A microprocessor comprising:
a computation unit for executing operations respectively associated with instructions of a determined set of instructions of the microprocessor;
a control unit for interpreting the instructions and controlling the computation unit accordingly; and
a blocking unit which is controlled by the control unit in response to the execution of a standby instruction belonging to said set of instructions for placing the microprocessor in a standby state, the exit of the microprocessor from the standby state being conditioned by a determined value or a determined change of the value of a condition bit stored in a condition register;
wherein the control unit is adapted to configure a bus to read the condition register so that it delivers the data stored in said condition register to the blocking unit.

2. The microprocessor according to claim 1, wherein the standby instruction comprises values specified as parameters of said instruction, including at least an address of the condition register and at least a rank of the condition bit in said condition register.

3. The microprocessor according to claim 2, wherein the values specified as parameters of the standby instruction further include the value of a parameter coding the change of the value of the condition bit which conditions the exit of the microprocessor from the standby state.

4. The microprocessor according to claim 2, further comprising an internal mode register for storing the value of a parameter coding the value or the change of value of the condition bit which conditions the exit of the microprocessor from the standby state.

5. The microprocessor according to claim 1, wherein the blocking unit comprises a selection unit for selecting, at each clock cycle of the microprocessor, the condition bit from among the bits of the condition register that are read by the bus in read mode.

6. The microprocessor according to claim 1, wherein the blocking unit comprises a monitoring unit for testing the condition bit at each clock cycle of the microprocessor.

7. The microprocessor according to claim 7. wherein the monitoring unit delivers a blocking signal on an input for activating and deactivating at least one unit for processing instructions belonging to the control unit, so as to interrupt and block the processing of the instructions in order to place the microprocessor in the standby state.

8. The microprocessor according to claim 7, wherein the unit for processing the instructions is a retrieval unit which retrieves, from a program memory, instructions to be executed.

9. The microprocessor according to claim 7, wherein the unit for processing instructions is an instruction register which stores an instruction to be executed.

10. The microprocessor according to claim 7, wherein the unit for processing instructions is an ordinal counter which stores the address of a next instruction to be executed.

11. The microprocessor according to claim 7, wherein the unit for processing instructions is a decoding unit which decodes an instruction to be executed.

12. The microprocessor according to claim 5, wherein the selection unit is a multiplexer comprising a number of input data which is equal to the size in number of bits of the condition register, addressing inputs representative of the coding of the rank of the condition bit in the condition register and an output which delivers the current value of the condition bit to the monitoring unit at each clock cycle of the microprocessor.

13. The microprocessor according to claim 6, wherein the monitoring unit is a multiplexer comprising two complementary inputs which respectively receive the value of the condition bit and its logical complement, an addressing input which receives the transition parameter and an output which delivers the blocking signal.

14. The microprocessor according to claim 6, wherein the monitoring unit is a comparator comprising two inputs which respectively receive the value of the transition parameter and the value of the condition bit, and an output which delivers the blocking signal.

15. The microprocessor according to claim 6, wherein the monitoring unit is an inverted XOR gate comprising two inputs which respectively receive the value of the condition bit and the transition parameter, and an output which delivers the blocking signal.

16. The microprocessor according to claim 6, wherein the monitoring unit is sensitive to a signal edge so as to react to a change of value of the condition bit.

17. A method for the control of a microprocessor comprising a computation unit for executing operations respectively associated with instructions of a determined set of instructions of the microprocessor and a control unit for interpreting the instructions and controlling the computation unit accordingly, comprises the steps of:
the control unit activating a blocking unit in response to the execution of a standby instruction;
a blocking unit interrupting and blocking the processing of the instructions so as to place the microprocessor in a standby state;
the control unit configuring a bus to read a condition register so that it delivers data stored in the condition register to the blocking unit; and
the blocking unit monitoring the value or the change of the value of a condition bit of the condition register which conditions the exit of the microprocessor from the standby state.

18. The method according to claim 17 further comprising a configuration step which comprises:
the specification of the address of the condition register as parameter of the standby instruction; and
the specification of the rank of the condition bit in the condition register as parameter of the standby instruction.

19. The method according to claim 18, wherein the configuration step comprises the specification of a transition parameter as parameter of the standby instruction whose value codes the value or the change of value of the condition bit which conditions the exit of the microprocessor from the standby state.

20. The method according to claim 18, wherein the configuration step furthermore comprises the configuration of a mode register internal to the microprocessor, so as to store in said mode register storing a transition parameter whose value codes the value or the change of the value of the condition bit which conditions the exit of the microprocessor from the standby state.

21. An apparatus, comprising:
a computation unit for a microprocessor;
a register storing a value indicative of whether the microprocessor is or is not in standby mode;
a control unit including an enable input and operable responsive to receipt of an enable signal in a first state to interpret program instructions and control operation of the computation unit according to those instructions and further operable responsive to receipt of the enable signal in a second state to interrupt and block processing of the program instructions; and
a blocking unit that configures a bus to read the value from the register and generates the enable signal in the first state if the microprocessor is not in standby mode and generates the enable signal in the second state if the microprocessor is in the standby mode.
